(19) United States
(12) Patent Application Publication
(10) Pub. No.: US 2026/0161825 A1
(43) Pub. Date: Jun. 11, 2026

(54) INSIGHTS GENERATION SYSTEM FOR AGENT-ASSISTED CONTENT MODERATION AND METHOD THEREOF

(71) Applicant: Accenture Global Solutions Limited, Dublin (IE)

(72) Inventors: Purvika BAZARI, Mumbai (IN); Kaushik SANYAL, Bangalore (IN); Himanshu GUPTA, Noida (IN)

(73) Assignee: Accenture Global Solutions Limited, Dublin (IE)

(21) Appl. No.: 18/971,549

(22) Filed: Dec. 6, 2024

(51) Int. Cl. G06F 21/64; G06F 16/28

(52) U.S. Cl. CPC G06F 21/64; G06F 16/285

(57) ABSTRACT

Method, system, and computer-readable media for generating insights for agent-assisted content moderation is disclosed. User-generated content (UGC) is enriched for enhancing accessibility and comprehension. The UGC stored is stored in a database. A plurality of articles relevant to the UGC is retrieved. Further, the UGC is classified into at least one content category of a plurality of content categories. One or more of a plurality of policy breaches corresponding to the at least one content category are identified, based on the enriched UGC and the retrieved plurality of articles. Cognitive ranking of the one or more of the plurality of policy breaches is generated. One or more actionable directives corresponding to the one or more of the plurality of policy breaches are generated for the user-generated content, based upon the cognitive ranking of the one or more of the plurality of policy breaches.

### TECHNICAL FIELD

Various examples described herein relate generally to computer-implemented method, computer system, and computer program product for generating insights for agent-assisted content moderation.

### BACKGROUND

In today's digital landscape, a rise of user-generated content (UGC) has fundamentally changed online interactions, allowing individuals to share their thoughts, creativity, and experiences with a global audience. The UGC includes various formats such as text, images, videos, and comments, encompassing social media posts, blogs, product reviews, user-created videos, and the like. The UGC reflects a rich mix of perspectives and ideas.

A transition from traditional media (where content creation is often limited to professionals) to a more open landscape has democratized content creation. The transition is driven by a widespread availability of digital tools and social media platforms. The transition enables anyone with internet access to create and share content or contribute to discussions. The transition also allows the individuals to express themselves without usual barriers of media. As a result, a broader range of voices and perspectives is shared in the digital landscape. Thus, a participatory culture fosters interaction and collaboration among the individuals, creating vibrant online communities where diverse voices connect over shared interests. Eventually, the UGC has significantly enriched the digital landscape, offering new opportunities for expression and engagement in an increasingly interconnected world.

### SUMMARY

Implementations of the present disclosure are generally directed to generation of insights for agent-assisted content moderation. More particularly, implementations of the present disclosure are directed to enriching user-generated content (UGC), retrieving relevant articles, and identifying policy breaches, to generate the insights, which in turn enhances decision-making for moderators, leading to improved efficiency and effectiveness in content moderation.

In general, innovative aspects of the subject matter described in this specification provide a computer-implemented method for generating insights for agent-assisted content moderation. The method may include enriching the UGC for enhancing accessibility and comprehension. The UGC may be stored in a database The method may include retrieving a plurality of articles relevant to the UGC. The method may further include classifying the UGC into at least one content category of a plurality of content categories. The method may further include identifying, based on the enriched UGC and the retrieved plurality of articles, one or more of a plurality of policy breaches corresponding to the at least one content category. The method may include generating cognitive ranking of the one or more of the plurality of policy breaches. The method may include generating, based upon the cognitive ranking of the one or more of the plurality of policy breaches, one or more actionable directives corresponding to the one or more of the plurality of policy breaches for the UGC.

The present disclosure further describes a system for implementing the method provided herein. The present disclosure also describes computer-readable media coupled to one or more processors and having instructions stored thereon which, when executed by the one or more processors, cause the one or more processors to perform operations in accordance with the method described herein.

It is appreciated that method in accordance with the present disclosure can include any combination of the aspects and features described herein. That is, the method in accordance with the present disclosure is not limited to the combinations of aspects and features specifically described herein, but also includes any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various examples in accordance with the present disclosure will be described with reference to the drawings, in which:

FIG. 1 illustrates an example environment that may be used to execute implementations of the present disclosure.

FIG. 2 illustrates a block diagram of an example system for generating insights for agent-assisted content moderation, in accordance with implementations of the present disclosure.

FIG. 3 illustrates an example process flow of content moderation within a platform implementing an insights generation system, in accordance with implementations of the present disclosure.

FIG. 4 illustrates a conceptual architecture of an insights generation system, in accordance with implementations described in this disclosure.

FIG. 5 illustrates an example process flow of a data enrichment block employed for enriching user-generated content (UGC), in accordance with implementations of the present disclosure.

FIG. 6 illustrates an example process flow of a computational model insights block employed for generating insights, in accordance with implementations of the present disclosure.

FIG. 7 illustrates an example process flow of a cognitive policy enforcement block employed for integrating cognitive intelligence with content moderation processes, in accordance with implementations of the present disclosure.

FIG. 8 illustrates an example scenario of enriching the UGC using a data enrichment block, in accordance with implementations of the present disclosure.

FIG. 9 illustrates an example scenario of an example scenario of generating enriched UGC, in accordance with implementations of the present disclosure.

FIG. 10 illustrates an example scenario of categorizing the UGC into a content category based on enriched data, in accordance with implementations of the present disclosure.

FIG. 11 illustrates an example scenario of integrating cognitive intelligence to enriched data, in accordance with implementations of the present disclosure.

FIG. 12 illustrates a flow diagram that presents an example method for generating insights for agent-assisted content moderation, in accordance with implementations of the present disclosure.

FIG. 13 illustrates an example computer system that may be used to implement an insights generation system.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same examples, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of an example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to;” it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope of the disclosure as set forth in the claims.

A rise of online platforms has led to an exponential increase in user-generated content (UGC). The UGC includes a diverse array of topics ranging from benign to potentially harmful subjects such as violence, hate speech, illegal activities, and/or the like. Proliferation of the UGC presents significant challenges for content moderation, as the online platforms strive to maintain community standards and ensure user safety.

Existing content moderation systems typically involve a combination of automated tools and human moderators to quickly filter out obvious violations based on predefined algorithms. However, the existing content moderation systems often struggle with complex content that requires contextual understanding, cultural awareness, and subjective judgment. Further, the human moderators play a crucial role in content moderation, tasked with reviewing and classifying the complex content or content that may not be easily categorized by the predefined algorithms.

To illustrate, an existing content moderation system includes a content moderation tool and a decision evaluation tool. The content moderation tool reviews metadata and content of the UGC to identify policy violations against pre-defined guidelines. The review includes checking transcripts or translations of the metadata and content for potential violations. Additionally, in some examples, the content moderation tool conducts external research by referencing policy documents, news articles, and seeking subject matter expert (SME) advice for clarification. After the external research conducted by the content moderation tool, the decision evaluation tool classifies the metadata and content based on pre-defined labels as approved, rejected, and/or or needs further review. Further, the decision evaluation tool records notes, and submits a decision to move on to a next task to be performed by the human moderators.

Despite expertise of the human moderators, the human moderators face considerable challenges in their work. One of the challenges may be high volume of the UGC generated on the online platforms, necessitating a quick and efficient review process. The high volume makes it difficult for the existing content moderation system and the human moderators to evaluate the entire UGC in a timely manner. As a result, there is a risk of shortcuts being taken, which may lead to oversight and compromised quality in the content moderation. Additionally, complexity of review procedures in the existing content moderation systems contribute to inefficiencies. The existing content moderation systems need to navigate lengthy procedures that often include multiple steps such as translating content (if applicable), consulting comprehensive policy documents to ensure accurate classification, and researching external sources to stay updated on emerging trends and contextual complexities. Performing the multiple steps may be time-consuming and may increase resource consumption and lead to delays in addressing content that requires immediate attention.

Furthermore, ambiguity in the UGC complicates content moderation efforts. For example, cases that involve complex social or cultural dynamics may require subject matter expertise. Consequently, the ambiguity may hinder the ability of the existing content moderation systems to make informed decisions promptly, affecting overall content moderation. Moreover, while harmful content demands immediate action, non-harmful content that may be processed swiftly is often caught in backlog, prolonging review cycle.

The timely removal or blocking of the harmful content or violating content is crucial for upholding platform integrity and ensuring compliance with legal and regulatory standards. In view of this, implementations of the present disclosure alleviate burdens faced by the human moderators. The implementations aim to provide content-related insights that may empower the human moderators to make informed decisions more efficiently. By reducing overall moderation workload, the implementations may enable the human moderators to concentrate on cases that necessitate their unique skills and perspectives, ultimately enhancing effectiveness and responsiveness of the content moderation on the online platforms.

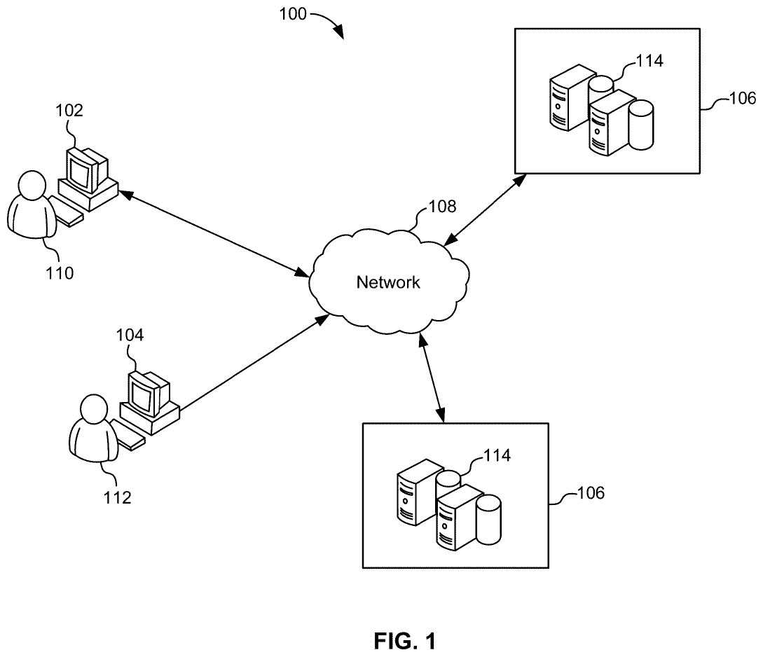

FIG. 1 illustrates an example environment 100 that may be used to execute implementations of the present disclosure. In some examples, the example environment 100 enables generation of insights for agent-assisted content moderation.

As depicted in FIG. 1, the example environment 100 includes computing devices 102 and 104, back-end systems 106, and a network 108. In some examples, the computing devices 102 and 104 are used by respective users 110 and 112 to log into and interact with computing platforms (or back-end systems 106) executing applications according to implementations of the present disclosure. Examples of the computing devices 102 and 104 may include a server, a notebook, a desktop, a netbook, smartphones, laptops, a tablet, and/or voice-enabled devices. It is contemplated that implementations of the present disclosure may be realized with any appropriate type of computing device. In some examples, each of the computing devices 102 and 104 may include a web browser application executed thereon, which may be used to display one or more web pages of a computing platform executing applications. In some examples, each of the computing devices 102 and 104 may display one or more Graphical User Interfaces (GUIs) that enable the respective users 110 and 112 to interact with the computing platforms.

In some examples, the network 108 may correspond to a communication network. Examples of the network 108 may include, but are not limited to, a Local Area Network (LAN), a Wide Area Network (WAN), the Internet, Wi-Fi, Long Term Evolution (LTE), Worldwide Interoperability for Microwave Access (WiMAX), General Packet Radio Services (GPRS), or a combination thereof. The network 108 communicatively couples or connects the computing devices 102 and 104 with the back-end systems 106. In some examples, the network 108 may be accessed over a wired and/or a wireless communication link. For example, a computing device like smartphone may utilize a cellular network to access the network 108.

In some examples, one or more of the back-end systems 106 may be implemented as an on-premises system that is operated by an enterprise or a third-party engaged in cross-platform interactions and data management. In some examples, the back-end systems 106 may be implemented as an off-premises system (for example, a cloud or an on-demand system) that is operated by an enterprise or a third-party on behalf of an enterprise. In some examples, the back-end systems 106 may be implemented in a cloud environment. For simplicity, the back-end systems 106 depicted in FIG. 1 may be a cloud environment that is intended to represent various forms of servers including a web server, an application server, a proxy server, a network server, a server pool, and/or the like.

In some examples, each of the back-end systems 106 includes insights generation systems 114. An insights generation system 114 may host components of enterprise systems and applications (for example, a social media management system and associated application). Also, the insights generation system 114 accepts requests from the users 110 and 112 (for example, human moderators) through the respective computing devices 102 and 104 for services being provided by the enterprise systems and the applications. The requests received from the users 110 and 112 through the respective computing devices 102 and 104 may be associated with assessment of user-generated content (UGC). Examples of the UGC may be a social media post including text, images, videos, and/or stories shared by individuals or groups on online platforms, comments and/or review (e.g., feedback provided on services, products, or content on the online platforms), blog posts and/or articles, forum discussions (e.g., conversations and threads created on online forums or community boards), podcasts and/or videos (e.g., audio or video content produced by the individuals or groups and shared on online platforms), polls and/or surveys (e.g., feedback or opinions collected from the individuals on the online platforms that allow the individuals to create and share polls, such as specialized survey sites), and/or the like. It should be noted that the UGC may be collected and assessed upon receiving explicit consent from the individuals or groups, who shared the UGC. The UGC may be stored and/or deleted per regulations and the consent received from individuals or groups. Therefore, the present disclosure operates only on the UGC that the individuals or groups have consented to.

In response to the requests, the insights generation system 114 performs moderation on the UGC by employing various models or agents (may be referenced hereinafter to as agent-assisted content moderation) and generates the insights for the agent-assisted content moderation. The moderation is a process of reviewing and managing the UGC on online platforms to ensure that the UGC adheres to community guidelines and policies. The moderation involves identifying and addressing inappropriate, harmful, or misleading content, such as hate speech, harassment, or spam. The moderation aims to create a safe and positive environment for users by maintaining quality and compliance within a community. Further, the agent-assisted content moderation is a hybrid approach where human moderators work alongside automated systems to evaluate the UGC. The automated systems flag potentially problematic content based on predefined criteria, allowing the human moderators to review and make final decisions. The insights may be further rendered to the users 110 and 112 through the respective computing devices 102 and 104.

According to implementations of the present disclosure, the insights generation system 114 may be adapted for generating insights for the agent-assisted content moderation, which is described in detail in conjunctions with figures below.

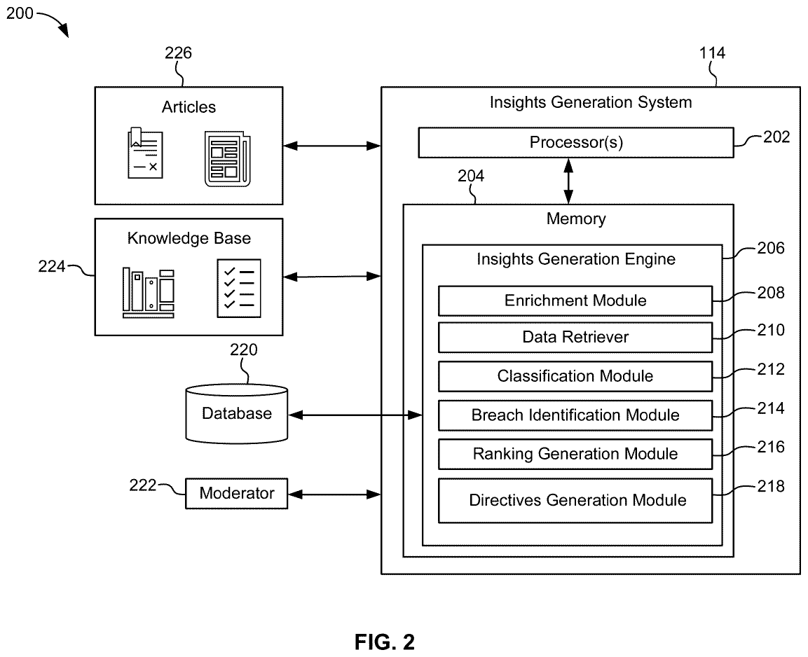

FIG. 2 illustrates a block diagram of an example system 200 for generating insights for agent-assisted content moderation, in accordance with implementations of the present disclosure. FIG. 2 is explained in conjunction with FIG. 1. As depicted in FIG. 2, the system 200 includes the insights generation system 114.

The insights generation system 114 includes a processor 202, and a memory 204. In some implementations, the insights generation system 114 includes more than one processor. The processor 202 may include, for example, microprocessors, microcomputers, microcontrollers, digital signal processors, central processing units, state machines, logic circuits, and/or any devices that manipulate data or signals based on operational instructions. The memory 204 may be a non-volatile memory or a volatile memory. Examples of the non-volatile memory may include, but are not limited to, a flash memory, a Read Only Memory (ROM), a Programmable ROM (PROM), Erasable PROM (EPROM), and Electrically EPROM (EEPROM) memory. Examples of the volatile memory may include, but are not limited, a Dynamic Random Access Memory (DRAM), and a Static Random-Access Memory (SRAM).

The memory 204 may be communicatively coupled to the processor 202. The memory 204 stores instructions, which upon execution by the processor 202, cause the processor 202 to perform various operations described in the present disclosure. The memory 204 includes an insights generation engine 206. The instructions stored in the memory 204 may define operations of the insights generation engine 206. The insights generation engine 206 includes an enrichment module 208, a data retriever 210, a classification module 212, a breach identification module 214, a ranking generation module 216, and a directives generation module 218.

In an implementation, the insights generation engine 206 may be coupled to a database 220. The database 220 stores various data and intermediate results generated by the components 208-218. For example, the database 220 may include classification results or content category of the UGC, identified policy breaches, rankings and directives associated with the policy breaches, and the like, which are described in detail below.

In some implementation, a moderator 222 (e.g., a user, administrator, and/or the like) may send a request to the insights generation system 114 via one of the associated computing devices 102 and 104. For example, the human moderator 222 may log into an application associated with the insights generation system 114 using corresponding user credentials. The moderator 222 may send the UGC along with a request to assess the UGC.

Once the assessment request is received, the enrichment module 208 may enrich the UGC for enhancing accessibility and comprehension ensuring that the UGC is clear and understandable. The enrichment module 208 may enrich the UGC using one or more textual analysis methods. For example, the textual analysis methods may involve sentiment analysis, language translation, and semantic extraction to enrich the UGC. The UGC may be enriched based upon one or more of image description, audio transcription, audio and/or video extraction, speech recognition, and/or machine translation. In detail, the enrichment module 208 initially processes and augments the UGC (e.g., multilingual or multimodal inputs across various media types, including images, videos, audio files, and/or text) to prepare the enriched UGC for subsequent utilization.

In some examples, the enrichment module 208 enhances the accessibility and comprehension of the UGC based upon image description, audio or video extraction, and audio transcription with translation capabilities, using cognitive attention techniques (e.g., using a cognitive attention Application Programming Interface (API)). The enrichment module 208 further utilizes Machine Learning (ML) models for image analysis, speech recognition, and machine translation, to improve accessibility and comprehension. Additionally, for text, the enrichment module 208 employs the textual analysis methods, including lexical analysis techniques like vectorization and text analytics, ensuring contextual understanding of the UGC.

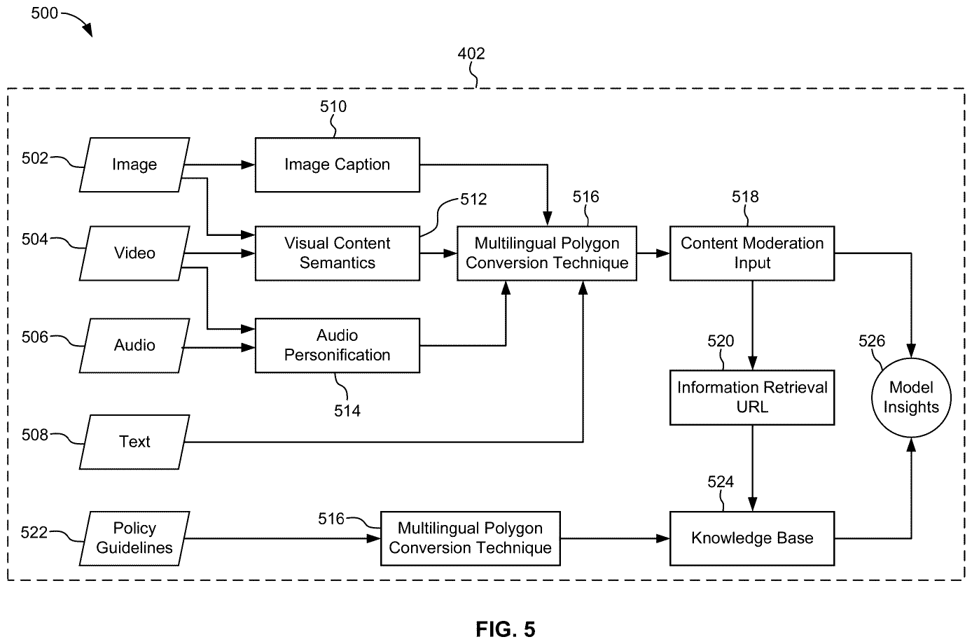

Along with enriching the UGC, the enrichment module 208 employs vector embeddings and vectorization techniques to enrich existing datasets and a knowledge base 224, using natural language information retrieval techniques and semantic analysis. Generation of the knowledge base is explained in detail in FIG. 5. Further, the enrichment module 208 utilizes dense and sparse retrievers for indexing and retrieving content, enabling deeper insights and improved information accessibility within the content corpus.

It should be noted that the original UGC (before processing through the enrichment module 208) and the enriched UGC may be stored in the knowledge base 224. The enrichment module 208 may be communicatively coupled to the data retriever 210.

The data retriever 210 may retrieve a collection of articles relevant to the UGC under assessment from various articles 226. The retrieved collection of articles may be stored in the knowledge base 224. The collection of articles may include one or more of an emerging trend (e.g., articles discussing a rise of misinformation during elections or growing popularity of a particular social media challenge), prevalent policy violations (e.g., reports or studies highlighting common violations, such as hate speech, cyberbullying incidents, or content that infringes copyright), policy information (e.g., documentation detailing specific platform policies on user behavior, content restrictions, or community guidelines, such as updates to harassment policies or new regulations on advertising), and a trending topic (e.g., articles covering current events or viral news stories, like discussions around climate change activism or major cultural phenomena, such as a widely shared meme or movement). The data retriever 210 leverages techniques such as web scraping and keyword extraction to retrieve the collection of articles. The collection of articles fortifies contextual relevance and/or comprehension. The data retriever 210 employs natural language processing (NLP) to generate queries that capture essence of the UGC, allowing for the identification of pertinent articles from a diverse range of sources. For example, the range of sources may include news websites, academic journals, blogs and opinion pieces, social media platforms, online forums and communities, government and regulatory websites, industry publications, content aggregators, and the like. The data retriever 210 calculates similarity scores using semantic vectors and embeddings extracted from a dialogue. A similarity score is a numerical measure that quantifies how similar two vectors (e.g., pieces of data) are based on a specific criterion. For example, the data retriever 210 calculates the similarity scores to determine how closely each of the retrieved collection of articles align with the UGC being assessed. By calculating the similarity scores based on the semantic vectors and the embeddings derived from the dialogues, it may be ensured that the collection of articles is contextually relevant and related to the specific queries. The dialogue may correspond with the generated queries and responses received for the queries. The similarity scores may be computed based upon a cosine similarity, a silhouette score, and an accuracy score, to ensure that the retrieved collection of articles is contextually relevant and aligned with the UGC being assessed. The data retriever 210 may be communicatively coupled to the classification module 212.

The classification module 212 may classify the UGC into a content category of various content categories. For example, the content categories may include, but are not limited to, hate speech, misinformation, harassment, adult content, spam, and/or copyright violations, and the like. The classification module 212 may use one or more transformers and contextual embeddings to classify the UGC content into the content category. For classification, the enriched UGC and the collection of articles may be retrieved from the knowledge base 224 and analyzed further to determine the content category. The enrichment module 208, the data retriever 210, and the classification module 212 may be communicatively coupled to the breach identification module 214.

The breach identification module 214 may identify one or more policy breaches of various policy breaches corresponding to the content category. The breach identification module 214 may identify the one or more policy breaches based on the enriched UGC and the retrieved collection of articles. By leveraging ML models, the breach identification module 214 may evaluate the UGC against a predefined policy criteria specific to the content category. For example, in the case of hate speech, the breach identification module 214 may look for aggressive language or derogatory terms, while for misinformation, the breach identification module 214 may analyze factual discrepancies in the UGC against verified information sourced from the retrieved collection of articles. The breach identification module 214 may be communicatively coupled to the ranking generation module 216.

The ranking generation module 216 may generate cognitive ranking of the one or more policy breaches. By way of an example, the cognitive ranking may be first, second, third, and the like. By way of another example, the cognitive ranking may include highest priority, medium priority, medium-low priority, lowest priority, and/or the like. To generate the cognitive ranking of the one or more policy breaches, the ranking generation module 216 may apply a timestamp and a severity indicator corresponding to each of the one or more policy breaches. Further, ranking generation module 216 may prioritize the one or more policy breaches based upon the severity indicator corresponding to each of the one or more policy breaches. In an implementation, various factors like recency, frequency, engagement, historical information and/or the like, may be considered to prioritize the one or more policy breaches. For example, if a hate speech breach is identified on MM-DD-YY (or MM-DD-YYYY), with a severity indicator of “9/10”, the hate speech breach may be ranked as a top priority due to its recent occurrence and high potential for harm. In contrast, a similar breach identified a week earlier may have a lower severity indicator of “5/10”. The ranking generation module 216 is communicatively coupled to the directives generation module 218.

The directives generation module 218 may generate one or more actionable directives corresponding to the one or more policy breaches for the UGC, based upon the cognitive ranking of the one or more policy breaches. The one or more actionable directives may include one or more of a content categorization recommendation, a list of policy violations, and a list of recommended actions, based on policy guidelines. The policy guidelines are a set of rules, principles, and/or standards established by an organization or a platform to govern behavior and content shared by the users 110 and 112. These policy guidelines outline what is considered acceptable and unacceptable conduct, providing clear expectations for user interactions and content submissions. The policy guidelines cover various topics, including prohibited behaviors (e.g., hate speech, harassment, and/or spam), content restrictions (e.g., copyright infringement, misinformation, and/or the like), and/or procedures for reporting violations. The policy guidelines serve to create a safe and respectful environment for the users 110 and 112, ensuring that everyone understands standards which need to be adhered to while engaging with the platform.

In an implementation, the directives generation module 218 may generate information providing clarification corresponding to the one or more policy breaches. The information may include explanations of the specific terms or phrases that triggered the violation, enhancing transparency and understanding for both the moderator 222 and the users 110 and 112. Further, the directives generation module 218 may identify an emerging trend and/or a common policy violation for the UGC. For example, if the high-priority breach is categorized as the hate speech, the directives generation module 218 may recommend tagging the high-priority breach specifically under “Hate Speech” or “Violent Content” to help the moderator quickly understand a nature of violation. Additionally, the directives generation module 218 may generate a comprehensive list of all identified policy violations, such as outlining that the UGC breaches both hate speech and misinformation policies. Additionally, the directives generation module 218 also provides suggested actions, which may include issuing a warning for the hate speech violation, removing the offending content immediately, recommending a temporary suspension for repeat offenses, and offering educational resources on acceptable behavior and community standards. Additionally, for example, if there is a noticeable increase in the hate speech related to a current event, the directives generation module 218 may flag this trend, prompting the insights generation system 114 to adjust its moderation strategies accordingly. For example, the moderation strategies may include increased monitoring of content related to specific events, targeted user education campaigns about community standards, and enhanced reporting tools for users. Other moderation strategies may involve implementing automated content filters for hate speech keywords, temporarily adjusting policies to address emerging issues, engaging with community leaders to promote positive dialogue, and conducting regular data analysis on hate speech trends to inform future moderation approaches. Further, the one or more actionable directives may be further presented to the moderator 222.

The actionable directives presented to the moderator 222 are utilized to guide decision-making in the content moderation process. The actionable directives help the moderator 222 to quickly assess policy violations by providing clear categorizations and prioritizing responses. The actionable directives outline recommended actions, such as issuing warnings or removing content, enabling the moderator 222 to respond effectively to the users 110 and 112. Additionally, the actionable directives involve accompanying explanations that enhance transparency by allowing moderator 222 to communicate clearly with users 110 and 112 about why the UGC is flagged. By highlighting emerging trends, the actionable directives help the moderator 222 to adjust their strategies proactively.

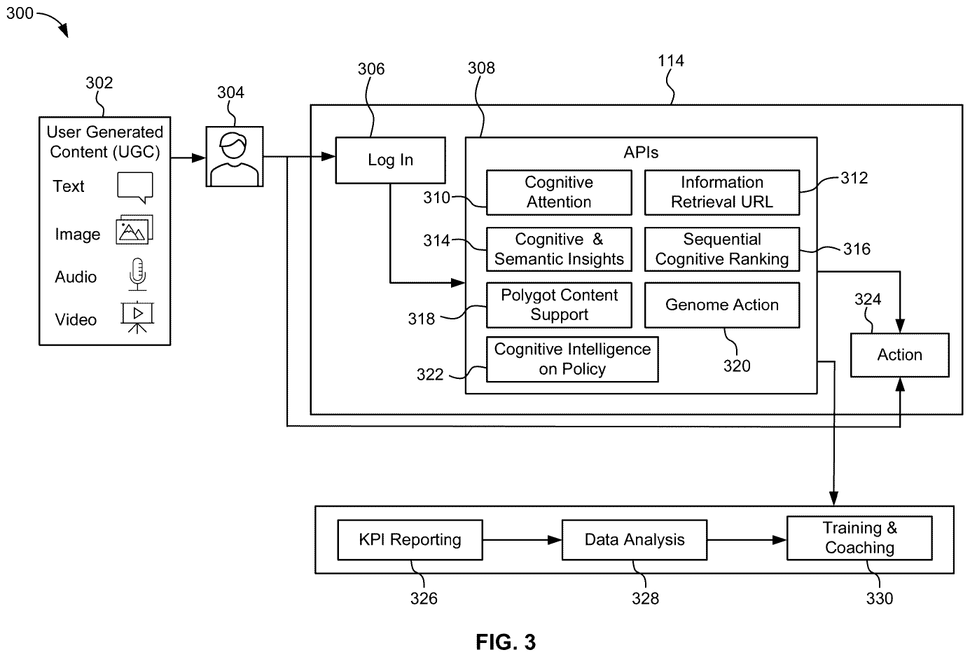

FIG. 3 illustrates an example process flow 300 of content moderation within a platform (e.g., a social media platform) implementing the insights generation system 114, in accordance with implementations of the present disclosure. FIG. 3 is explained in conjunction with FIGS. 1-2. The process flow 300 includes various operations for reviewing UGC 302 and ensuring compliance with established policy guidelines. The process flow 300 begins with receiving the UGC 302, which serves as the primary input requiring moderation. The UGC encompass a variety of formats, including a text, an image, a video, and an audio.

Once the UGC 302 is received, a content moderator 304 (analogous to the moderator 222) is assigned to a task of reviewing the UGC 302. The assignment of the content moderator 304 ensures that there is a designated individual responsible for evaluating the UGC 302 against the policy guidelines of the platform. The content moderator 304 then performs a log-in operation 306 or logs into the insights generation system 114, where the content moderator 304 may view and manage the assigned task.

To aid in decision-making process, the insights generation system 114 utilizes various Application Programming Interfaces (APIs) 308 to generate insights that assist the content moderator 304. The APIs 308 include cognitive attention 310 for enhanced content analysis, information retrieval Uniform Resource Locators (URLs) 312 that fetch pertinent articles and resources for the UGC 302, and cognitive and semantic insights 314 that analyze the UGC 302 for potential policy breaches and sentiments. Additionally, the APIs 308 include a sequential cognitive ranking 316 that prioritizes content of the UGC 302 based on the severity of violations of the policy guidelines, and polyglot content support 318 that ensures clarity across multilingual content of the UGC 302. Further, the APIs 308 include genome action API 320 to facilitate targeted genome actions or insights based on analysis of the UGC 302, and cognitive intelligence on policy 322 to provide contextual understanding of relevant policy guidelines.

Further, the insights may be reviewed by the content moderator 304. After reviewing the insights generated by the APIs 308, the content moderator 304 may submit an action 324. The submitted action 324 may include records of moderation notes and a decision regarding the UGC 302 generated by the content moderator 304. The decision may range from approval to rejection or flagging the UGC 302, after which the content moderator 304 moves on to a next task. The insights from the APIs 308 enable the content moderator 304 to access relevant information rapidly, making the review process more efficient.

The insights generated from the APIs 308 are then leveraged by Subject Matter Experts (SMEs) and team leads to conduct policy training and coaching sessions. The process policy training and coaching sessions are informed by the insights derived from the APIs 308. For example, Key Performance Indicator (KPI) reporting 326 is performed based on the insights. KPIs such as Average Handling Time (AHT) and quality scores are tracked and monitored continuously. The KPIs are analyzed to identify performance trends and areas that require attention. Through frequent KPI reporting 326, the SMEs and team leads may gain insights into which policies are causing inefficiencies or quality issues, helping to prioritize training needs. Furthermore, the SMEs and the team leads conduct data analysis 328 on key metrics or the KPIs of evaluation of effectiveness and efficiency of the content moderation processes. By reviewing the AHT and quality reports including the quality scores, the SMEs and team leads may identify patterns and pinpoint specific policies that are leading to errors or misunderstandings. The data analysis 328 also helps to detect any gaps in knowledge, particularly when new policies or process updates are introduced. Based on the data analysis 328, the SMEs and the team leads may determine where training or coaching sessions 330 are needed to address these issues (errors, misunderstandings, and/or gaps in knowledge). Further, regular training and coaching sessions 330 are held to address the issues and to update the content moderator 304 on any changes to policies or processes, ensuring that the content moderator 304 remains knowledgeable and effective in a corresponding role. The process flow 300 provides a data-driven approach that helps refine policies and improve overall moderation quality, thereby enhancing the efficacy of the content moderation in maintaining compliance with policy guidelines of the platform.

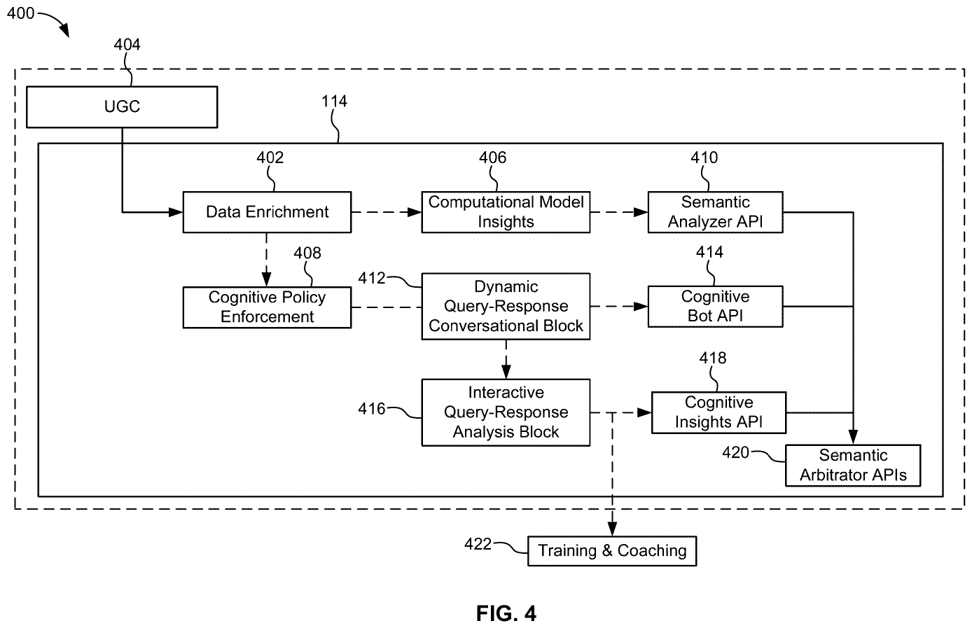

FIG. 4 illustrates a conceptual architecture 400 of the insights generation system 114, in accordance with implementations of the present disclosure. FIG. 4 is explained in conjunction with FIGS. 1-3.

The architecture 400 includes a data enrichment block 402, where UGC 404 is enriched through various methods involving, such as image captioning, audio transcription, and semantic analysis, while ensuring the UGC 404 is accessible and ready for further analysis. The enriched UGC then is processed using a computational model insights block 406 and a cognitive policy enforcement block 408.

In the computational model insights block 406, the enriched data is utilized to generate insights through advanced computational models, which analyze the enriched UGC for policy adherence and emerging trends. The computational model insights block 406 is coupled to a semantic analyzer Application Programming Interface (API) 410, which processes the insights to identify potential policy breaches. Concurrently, the cognitive policy enforcement block 408 leverages the enriched UGC to support moderators (e.g., including the moderator 222) in making informed decisions, connecting to a dynamic query-response conversational block 412 that facilitates real-time interactions between the moderators and the system 200.

The dynamic query-response conversational block 412 allows the moderators (not shown in FIG. 4) to ask questions and receive contextual answers regarding content policies and guidelines. The dynamic query-response conversational block 412 is coupled to a cognitive bot API 414, providing quick answers, and an interactive query-response analysis block 416, which analyzes conversations to extract valuable insights. Outputs from the interactive query-response analysis block 416 are fed into a cognitive insights API 418 and training/coaching sessions 422 aimed at refreshing the moderators on policy updates and correcting errors.

The insights from the semantic analyzer API 410, the cognitive bot API 414, and the cognitive insights API 418 may be converted into the semantic Arbitrator APIs 420, consolidating information to support content moderation decisions comprehensively. Therefore, the insights generation system 114 ensures that the moderators are equipped with relevant insights, enhancing the overall efficiency and effectiveness of the content moderation process.

FIG. 5 illustrates a process flow 500 of the data enrichment block 402 employed for enriching the UGC, in accordance with implementations of the present disclosure. In some implementations, the process flow 500 may be implemented within the insights generation system 114. FIG. 5 is explained in conjunction with FIGS. 1-4.

The process flow 500 begins with receiving an initial input. The initial input may be the UGC. The UGC may be received in one or more of multiple forms of content, including an image 502, a video 504, an audio 506, and a text 508. The initial input is further processed to transform the multiple forms of the content into enriched formats (e.g., to generate enriched UGC). For example, from the image 502, an image caption 510 and visual content semantics 512 are retrieved. For retrieving the image caption 510, an ML model may be used. Further, for retrieving the visual content semantics 512, a computer vision technique may be used. The visual content semantics 512 are retrieved by identifying and categorizing objects, attributes of the objects, and relationships among the objects, within the image 502. The image caption 510 provides descriptive summaries that enhance understanding of visual context of the image 502, while the visual content semantics 512 capture key elements and their relationships from the image 502. For example, if the image 502 depicts a dog in a park, the image caption 510 may be “dog playing in a sunny park.” The image caption 510 helps to understand visual content of the image 502 without needing to view the image 502 directly.

Further, in the case of the video 504, the visual content semantics 512 are retrieved which provide significant visual and auditory components. Video analysis techniques may be employed to extract significant visual and auditory components, resulting in the retrieval of the visual content semantics 512. Also, in case of the video 504, an audio personification 514 is performed to convert spoken content or auditory components into a text. A speech recognition technique is used for performing the audio personification 514. By using the speech recognition technique, the spoken content in the video 504 may be transcribed into the text. By retrieving the visual content semantics 512 and performing the audio personification 514, critical aspects of the video 504 are summarized and made accessible.

Further, in case of the audio 506, the audio personification 514 is performed using a speech-to-text technique, converting spoken content in the audio 506 into text to provide clear insights into the audio 506. As a result, the enriched UGC may be obtained based on the retrieving the image caption 510, visual content semantics 512, and performing the audio personification 514. To obtain the enriched UGC, in some implementations, cognitive attention (e.g., the cognitive attention 310) may be used, which helps to focus on the most relevant parts of the initial input. For example, in the video 504, information extracted from scenes that have the most visual activity or significant speech may be prioritized, ensuring that the most important elements (e.g., visual and auditory elements) are highlighted in the enriched content. In the case of the image 502, features from regions with the most visual detail or interest may be prioritized. For example, if the image 502 depicts a bustling city street, the regions such as landmarks, people and activities, color and composition, and the like, may be prioritized. For the audio 506, key segments based on speech activity and tone (e.g., engaging moments) may be prioritized.

Further, to generate the enriched UGC, textual analysis may be performed. For example, a lexical analysis technique including vectorization may be used to transform the text 508 or the text generated from the image 502, video 504, and/or the audio 506 into numerical representations that capture semantic meaning. The textual analysis helps in processing and analysing large amounts of textual data efficiently. Additionally, advanced methods, including vector embeddings and vectorization may be used, to generate the enriched UGC. The data enrichment block 402 employs textual analysis algorithms, such as natural language information retrieval techniques, vectorization, and semantic analysis guided by the cognitive attention 310. Dense and sparse retrievers are utilized for indexing and retrieving the UGC, facilitating deeper insights and improved information accessibility within the content corpus.

The enriched UGC is processed using a multilingual polygon conversion technique 516. The multilingual polygon conversion technique 516 facilitates effective communication across various languages, ensuring that the moderators are able to interpret and respond to the UGC accurately, regardless of original language of the UGC. Results of the processing using the multilingual polygon conversion technique 516 provides clear contextual insights that support a stage of content moderation input 518, forming a basis for evaluating the UGC against established guidelines and standards. The content moderation input 518 may include the UGC, metadata (accompanying information about the UGC, such as timestamps, user IDs, geolocation data, and context about how the UGC is submitted (e.g., a platform used)), contextual information of the UGC, previous moderation decisions, and/or the like.

Further, the process flow 500 employs an information retrieval URL 520 (e.g., the information retrieval URL 312) to dynamically gather relevant articles and resources through web scraping. The information retrieval URL 520 provides a capability to search for and collect information from external sources, such as online news articles or relevant web content. The information retrieval URL 520 specifically uses the web scraping technique, which involves automatically extracting data (e.g., articles) from websites. The integration links back to earlier content processing by enriching context available to the moderators with current and pertinent information of the articles. In other words, by gathering current and pertinent information of articles relevant to the UGC, context in which the moderators operate may be enhanced. For example, if there is a trending topic or recent event related to the UGC under review, the trending topic or recent event may be gathered which provides important context for decision-making. The integration of the retrieved information (e.g., relevant articles) with the enriched UGC ensures that the moderators have comprehensive insights or model insights 526 to guide their decisions.

In parallel, the process flow 500 includes determining policy guidelines 522 relevant to the UGC. Further, the multilingual polygon conversion technique 516 is used for translating the policy guidelines 522 into multiple languages as needed. The translation involves not just direct translation but also contextual adaptation to ensure that complexity of the policy guidelines 522 is preserved in each language. The purpose of using the multilingual polygon conversion technique 516 is to ensure that the policy guidelines 522 are accessible to the moderators, regardless of their primary language. The translation ensures that the moderators have clear, accessible instructions for assessing the UGC, enhancing understanding and compliance with established policy guidelines.

Further, a comprehensive knowledge base 524 (same as the knowledge base 224) is generated based on the information retrieved (e.g., articles) and the policy guidelines 522. This knowledge base 524 consolidates curated policy documents, relevant articles, and insights derived from the enriched UGC. The knowledge base 524 is cohesive knowledge base that strengthens connection between the UGC and the insights generation system 114, fostering consistency and informed decision-making.

Further, in some implementations, the knowledge base 524 and the content moderation input 518 are leveraged to generate actionable or model insights 526 for the moderators. The actionable or model insights 526 are generated to guide decision-making, highlight potential policy violations, and suggest appropriate responses based on the enriched UGC and knowledge base 524.

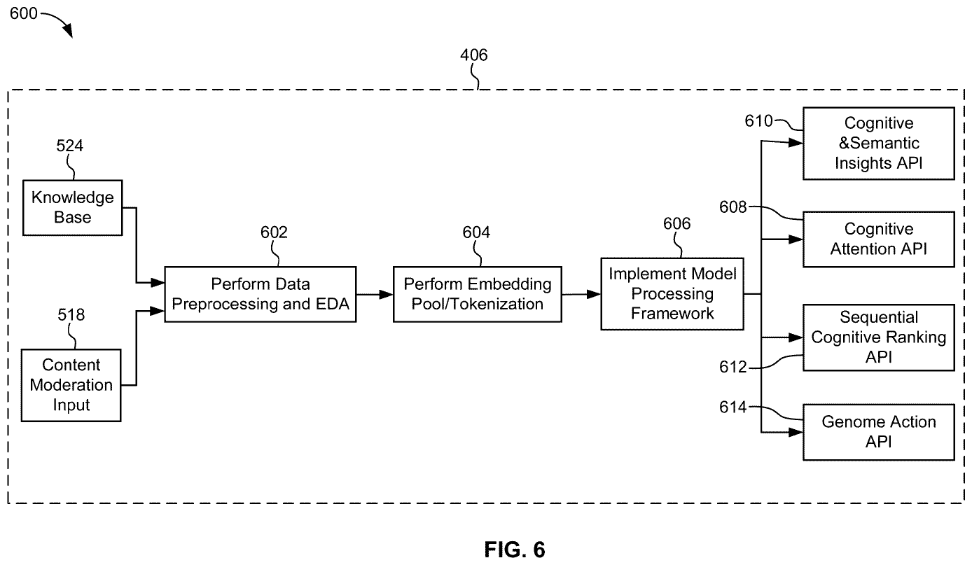

FIG. 6 illustrates a process flow 600 of the computational model insights block 406 employed for generating insights, in accordance with implementations of the present disclosure. In some implementations, the process flow 600 may be implemented within the insights generation system 114. FIG. 6 is explained in conjunction with FIGS. 1-5.

The process flow 600 includes performing 602 data preprocessing and Exploratory Data Analysis (EDA), based on the knowledge base 524 and the content moderation input 518. The knowledge base 524 includes curated data, policies, and historical moderation decisions, while the content moderation input 518 includes the enriched UGC that requires assessment, as already has been explained in FIG. 5. The performing 602 data preprocessing and EDA includes cleaning and organizing data of the knowledge base 524 and the content moderation input 518, and identifying patterns in the data, and establishing key metrics (such as moderation response time, false positive rates, false negative rates, user satisfaction scores, and/or the like) that may guide subsequent stages. Effective preprocessing is crucial for ensuring that the data is reliable and ready for further analysis.

Once the data preprocessing is performed 602, the process flow 600 proceeds with performing 604 embedding pool and tokenization. Here, the pre-processed data is transformed into a format suitable for model training and inference. The tokenization breaks down text into manageable units (e.g., tokens), while embedding techniques create dense vector representations or vector embeddings that capture semantic meaning of the UGC. The dense vector representations are continuous representations where each element in a vector holds real-valued numbers. The dense vector representations may aid in understanding of context and relationships within the data effectively.

The process flow 600 further includes implementing 606 a model processing framework. In the model processing framework, various advanced algorithms including transformers and contextual embeddings, are applied to analyze the enriched UGC. The model processing framework enables extraction of deeper insights by utilizing NLP techniques. As a result, the moderators may access actionable insights that facilitate rapid and informed decision-making regarding content moderation.

Further, insights may be generated by a cognitive semantic and insights API 610 (e.g., the cognitive semantic and insights 314) and using the model processing framework. In an implementation, a cognitive attention API 608 (e.g., the cognitive attention 310) may be employed. The cognitive attention API 608 may enhance precision of content classification, enabling differentiation between violating and non-violating content types. In some implementations, by employing dense retrievers and fusion-in-decoder architectures, complex contextual information that significantly improves semantic understanding of the UGC may be captured. A shift from sparse to dense representations allows for data-driven decision-making, leading to more accurate moderation outcomes.

The insights generated using the cognitive semantic insights API 610 may enhance the moderation process by providing detailed examinations of the UGC. The insights include comprehensive explanations of potential policy breaches, such as hate speech or violence, which are critical for the moderators to understand implications of their decisions. Further, document encoders may be integrated to ensure a complex understanding of semantics involved, offering granular insights that support the content moderation process.

Further, a sequential cognitive ranking API 612 (e.g., the sequential cognitive ranking 316) is employed to generate ranking. The sequential cognitive ranking API 612 introduces timestamping techniques and severity indicators into the moderation process, allowing for a prioritized assessment of the UGC. By generating the ranking, it may be ensured that the most severe policy breaches are identified and addressed promptly, thereby optimizing the content moderation process, particularly in cases of repeated infractions. The repeated infraction refers to instances where the policy guidelines are repeatedly violated.

Moreover, a genome action API 614 (e.g., the genome action API 320) may be used to autonomously generate genome actions or actionable directives based on severity of violations. The genome actions or the actionable insights may include recommendations for content deletion, blocking, or approval, which empowers the moderators to make data-driven decisions that align with precise directives. By optimizing the content moderation process through automated recommendations, overall efficiency and accuracy of the content moderation are significantly enhanced. All the features and the insights of the process flow 600 are encapsulated within the semantic analyser API 410 (depicted in FIG. 4), which serves as a tool for improving effectiveness and precision of content moderation. The semantic analyser API enables a more informed workflow, ensuring that the moderators are equipped with the necessary insights to navigate complex content scenarios effectively.

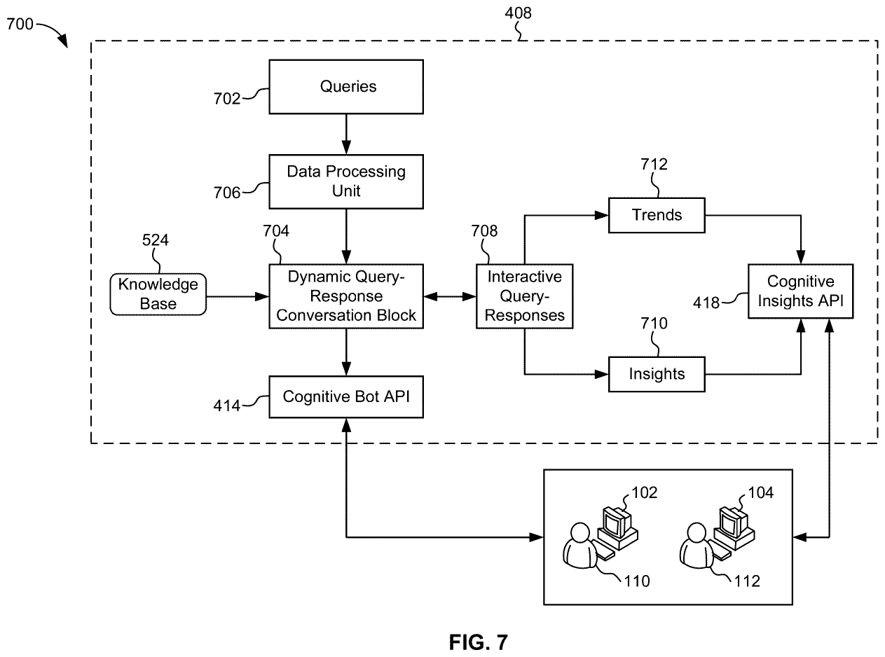

FIG. 7 illustrates a process flow 700 of the cognitive policy enforcement block 408 employed for integrating cognitive intelligence with content moderation processes to enrich the UGC, in accordance with implementations of the present disclosure. In some implementations, the process flow 700 may be implemented within the insights generation system 114. FIG. 7 is explained in conjunction with FIGS. 1-6.

The cognitive policy enforcement block 408 is employed for integration of cognitive intelligence with the content moderation processes which streamlines the content moderation processes by leveraging the knowledge base 524 that includes policy documents and articles. The cognitive policy enforcement block 408 employs advanced NLP and Artificial Intelligence (AI) techniques or machine learning capabilities to provide responses to moderator queries, facilitating a deeper understanding of policy frameworks.

The knowledge base 524 serves as the foundational repository of policy documents and relevant information. By integrating the knowledge base 524 to the cognitive policy enforcement block 408, a process of addressing policy-related inquiries may be addressed, eliminating a need for manual consultations and extensive research, which may be time-consuming for the moderators. The cognitive policy enforcement block 408 provides the moderators with a comprehensive suite of resources, including policy guidelines, rulebooks, and supplementary materials.

The process flow 700 includes receiving queries 702 dynamically from moderators. The queries 702 may be specific questions regarding content moderation policies. Further, the process flow 700 includes processing the queries 702 to a dynamic query-response conversation block 704 using a data processing unit 706. The data processing unit 706 is also used to process responses to the moderators, ensuring that the moderators receive timely and relevant responses. Through interactive engagement using the dynamic query-response conversation block 704, the moderators may efficiently address queries and clarify policies, benefiting from rapid and contextually relevant responses that enable informed decision-making.

The dynamic query-response conversation block 704 employs advanced cognitive approaches, utilizing vector embeddings and conversational AI techniques. The dynamic query-response conversation block 704 provides a structured way for the moderators to access content moderation policies, clarifying any ambiguities the moderators may encounter during a review process. By using NLP for semantic understanding and vector embeddings for efficient policy retrieval, the dynamic query-response conversation block 704 ensures that the moderators may quickly find information (e.g., recent updates in policy guidelines, best practices, and the like) needed, empowering the moderators to make informed decisions without relying heavily on manual searches.

Additionally, the process flow 700 integrates the cognitive bot API 414, which consolidates policy enforcement functionalities. The cognitive bot API 414 automates application of policy guidelines and streamlines adherence to the policy guidelines. Therefore, the cognitive bot API 414 may allow the users 110 and 112 (e.g., moderators) associated with the computing devices 102 and 104 to dedicate more time to evaluating content rather than engaging in resource-intensive research. The cognitive bot API 414 leads to a significant improvement in operational efficiency, as the moderators may focus on their primary responsibilities.

Further, the process flow 700 includes performing an interactive query-response analysis 708. The interactive query-response analysis 708 performed using advanced NLP techniques to analyze conversational data received from the dynamic query-response conversation block 704. Semantic vectors and embeddings from dialogues may be analyzed, providing insights 710 into emerging trends 712, prevalent policy violations, and trending topics within the UGC. The interactive query-response analysis extracts actionable insights through trend analysis, providing the moderators with a deep understanding of emerging trends, prevalent policy violations, and trending topics. The insights 710 may be translated into actionable data points, such as identifying the most common violations, frequently asked questions (FAQs), and areas that require improvement. By employing vector space models and embedding techniques, clusters of similar inquiries may be detected and any anomalies or shifts in conversational patterns may be identified.

The process flow 700 includes providing structured, and real-time analytics to the computing devices 102 and 104 through the cognitive insights API 418. Therefore, the users 110 and 112 (e.g., team leads) associated with the computing devices 102 and 104 may be facilitated to make informed decision. The cognitive insights API 418 enables formulation of targeted training and coaching regimens for content moderators, tailored specifically to address emerging topics and queries. By leveraging the cognitive insights API 418, significant violations and areas requiring improvement may be highlighted, supporting development of customized training plans for moderators, tailored to address specific needs identified through the interactive query-response analysis. This cognitive insights API 418 enhances the effectiveness of content moderation by ensuring the moderators are well-informed and equipped to handle evolving challenges in real-time. Therefore, moderation accuracy and effectiveness to reduce error rates may be enhanced.

Referring back to FIG. 4, the semantic arbitrator APIs 420 consolidate the semantic analyzer API 410, the cognitive bot API 414, and the cognitive insights API 418 into a cohesive framework for effective content moderation. The semantic arbitrator APIs 420 supports seamless integration into existing moderation systems or facilitates development of tailored interfaces to meet specific enterprise requirements. The semantic analyzer API 410 offers guidance on content categorization, identifies policy violations, and suggests appropriate actions based on policy guidelines, utilizing semantic embeddings and vector representations to enhance accuracy in content classification and policy enforcement. The cognitive bot API 414 enables quick assistance and clarification on policy-related queries during content review, ensuring that the moderators have required support in real time. The cognitive insights API 418 incorporates trends 712 and insights 710 generated from bot conversations, providing valuable data on emerging trends, common policy violations, and actionable insights. The semantic arbitrator APIs 420 serves as a robust asset for effective content moderation and decision-making, offering the moderators rapid access to a comprehensive knowledge base 524. The semantic arbitrator APIs 420 integrates functionalities such as content tagging, automated policy enforcement, interactive conversation, and data-driven analytics, significantly enhancing moderation efficiency and decision-making in content moderation processes.

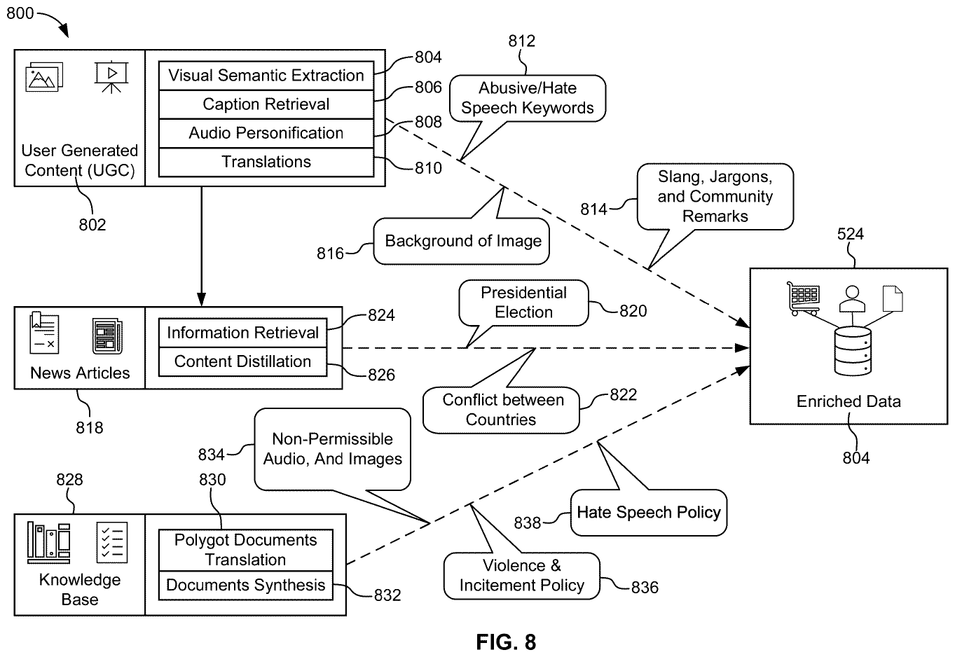

FIG. 8 illustrates an example scenario 800 of enriching UGC using the data enrichment block 402, in accordance with implementations of the present disclosure. In some implementations, the scenario 800 may be implemented within the insights generation system 114. FIG. 8 is explained in conjunction with FIGS. 1-7.

In an implementation, the data enrichment block 402 may receive UGC 802. The UGC 802 may include various forms such as text, images, audio, and video. The data enrichment block 402 uses a visual semantic extraction technique 804, which analyzes visual content to identify key elements and context. The data enrichment block 402 uses a caption retrieval technique 806 that enhances the UGC 802 by generating descriptive summaries that clarify content of images. Further, the data enrichment block 402 utilizes an audio personification technique 808 to convert spoken language from audio clips into text, facilitating easier analysis. Moreover, the enrichment block 402 utilizes translations 810 to convert the UGC 802 from multiple languages into a common language, ensuring that the UGC 802 is accessible and understandable for the moderators. The translations 810 may capture linguistic complexities, slang, and community-specific expressions, preventing misunderstandings during evaluation. For example, the data enrichment block 402 identifies abusive and hate speech keywords 812, as well as slang, jargon, and community remarks 814, and describes background of images 816 which are critical for assessing the UGC 802 against community standards. This holistic analysis of UGC 802 allows for the generation of enriched data that is contextually relevant and useful for moderation.

In some implementations, for the text, sentiment analysis may be performed using NLP techniques to evaluate emotional tone of the text, generating sentiment vectors that capture underlying emotional complexities. Additionally, the NLP techniques are employed to create embeddings that identify and flag instances of abusive language or hate speech. By utilizing the NLP techniques, harmful content may be detected, enhancing the ability to understand and mitigate negative interactions in communication. For the images, the visual semantic content extraction technique 804 such as computer vision technique is employed to extract semantic information from the images, generating embeddings that represent both the image content and its contextual background. As a result, detailed summaries of visual data may be obtained. Additionally, for the images, the caption retrieval technique 806 (e.g., deep learning models) is utilized to extract captions from images, providing further context and enhancing the overall understanding of the visual content.

For the audio and video automatic speech recognition (ASR) techniques are used, which transcribe the spoken words and translate any language into a standard language (e.g., English), enhancing accessibility and understanding. To ensure compliance with community guidelines, the transcribed text undergoes temporal analysis using time-stamped data to detect and flag restricted words, slang, or any other content that violates established policies. The temporal analysis utilization of compliance techniques to effectively monitor and enforce adherence to community guidelines.

In an implementation, insights from news articles 818 may be retrieved, particularly in context of significant events like the presidential election of a country 820 and conflict between countries 822. Here, retrieval process involves information retrieval 824 using the information retrieval URL 312 or 520 to gather pertinent data from various news sources. The pertinent data is then subjected to content distillation 826, which distills complex information into concise summaries or insights, making it more accessible and relevant for the moderators. By synthesizing information from the news articles, the enriched generated provides a clearer understanding of the narratives surrounding these events. The news articles 818 may undergo an abstraction process using summarization techniques to generate concise insights, thereby reducing the need for extensive external research.

Further, policy documents and rule books are translated and compiled into a comprehensive knowledge base 524 utilizing translation algorithms and knowledge graph construction techniques. In an implementation, knowledge base resources (e.g., policy documents, rule books, translated materials, training materials, examples of violations, and/or the like) are integrated, and polyglot documents are handled. The integration and handling include polygot documents translation 830, ensuring that content in multiple languages is accurately interpreted. Further, document synthesis 832 is performed to provide coherent insights while identifying and flagging non-permissible audio and images 834, such as those promoting extremist ideologies like a particular flag of a group. Furthermore, the knowledge base 828 incorporates policies related to violence and incitement policy 836 and hate speech policy 838, ensuring that all enriched data aligns with established community guidelines. As a result, utility of the knowledge base 828 may be enhanced in the context of the content moderation.

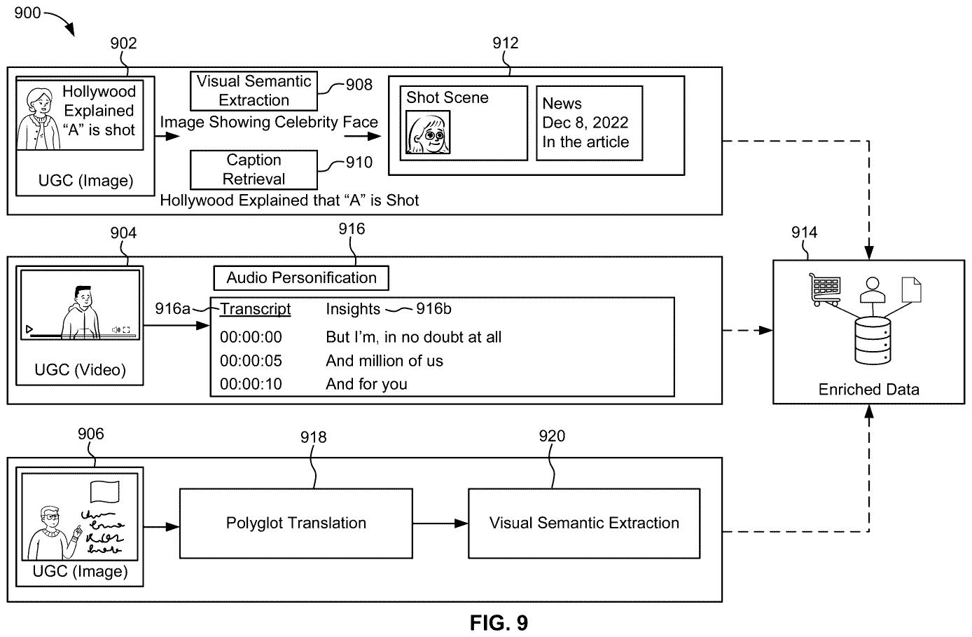

FIG. 9 illustrates an example scenario 900 of generating enriched UGC, in accordance with implementations of the present disclosure. In some implementations, the scenario 900 may be implemented within the insights generation system 114. FIG. 9 is explained in conjunction with FIGS. 1-8.

In some implementations, a UGC including a first image 902, a video 904, and a second image 906 may be received for data enrichment. As illustrated in FIG. 9, for the first image 902, visual semantic extraction 908 (which analyzes visual elements and context), and caption retrieval 910 may be performed on the image 902. As a result of performing the visual semantic extraction 908, an output as “image showing celebrity A's face” may be generated, providing a clear identification of a main subject (e.g., celebrity A) within the first image 902. By performing the caption retrieval 910, a descriptive caption or an output as “A is shot” may be generated. The descriptive caption adds further context, indicating an action or scene depicted in the first image 902. Further, news articles 912 related to the image 902 may be retrieved. The new articles 912 provide relevant information and context surrounding the first image 902. For example, if the first image 902 features the celebrity A, the retrieved articles 912 may discuss recent events or news involving the celebrity A, enriching overall understanding of the UGC. Through the visual semantic extraction 908, caption retrieval 910, and contextual news article integration, the first image 902 is transformed into enriched data 914 that offers a comprehensive view of the first image 902.

In some implementations, long texts or phrases may be managed effectively, mitigating issues of truncation or context loss that is common in other standard systems. Preceding and succeeding information may be leveraged as context to generate rich and more comprehensive embeddings. For example, if the sentence is long, embedding for “Hollywood” is influenced by the following context “A is shot”, and vice versa ensures that the embeddings are not isolated but rather enriched by the full sentence context.

In an implementation, two types of embeddings (e.g., dense embeddings, which capture rich semantic details, and sparse embeddings, which are particularly effective for representing domain-specific terms) of textual data associated with the UGC may be generated. The dense embeddings encapsulate a broad semantic context, while the sparse embeddings ensure accurate representation of critical, domain-specific terminology. The generation of two types of embedding facilitate a more accurate understanding of the UGC, balancing broad contextual comprehension with precise term recognition.

For example, for the domain-specific scenario 900 which includes the first image 902 representing an entertainment news, standard embedding for the term “celebrity A” may be represented as [0.1, −0.2, 0.4, . . . , 0.6]. The proposed embeddings are used to capture domain-specific associations as a TV celebrity-named entity within the entertainment domain, resulting in a representation of [0.3, −0.1, 0.5, . . . , 0.7]. Similarly, a phrase “Hollywood explained” may be broken down into dense vectors [0.4, −0.3, 0.2, . . . , 0.5], which capture semantic understanding within the context of the entertainment industry, and sparse vectors [0.1, 0.0, −0.1, . . . , 0.2], which focus on explanatory contexts. As a result, it may be ensured that the embeddings for “Hollywood explained” are not isolated but are deeply informed by the entire phrase, effectively capturing complex meanings and contexts.

To retrieve the news articles 912, various metrices may be determined for various news articles. For example, a cosine similarity score, a silhouette score, and a classification accuracy, may be determined for various URLs (e.g., URL 1, URL 2, URL 3, URL 4, and URL 5) corresponding to the various news articles. In detail, the URLs are scraped based on keywords, and corresponding vector embeddings are generated. For each URL, the cosine similarity is calculated between embedding generated for the first image 902 and the embeddings of each URL. The cosine similarity quantifies a cosine of an angle between two vectors to indicate their similarity, providing a numerical indication of their similarity. Higher cosine similarity scores denote greater relevance, suggesting that a URL is more closely related to content of the first image 902. denoting greater relevance. Additionally, the silhouette score is computed to measure cohesion and separation of the embeddings of the URL in relation to a query, providing insight into the quality of clustering-higher scores indicate more distinct and relevant groupings. The classification accuracy is then evaluated to assess the effectiveness of URL classification. Finally, the metrics (e.g., the cosine similarity, silhouette score, and the classification accuracy) are aggregated into a single relevance score (e.g., a combined score) for each URL using a specified formula as per equation (1), given below:

Combined Score=(Cosine Similarity+Silhouette Score+Classification accuracy/100)/3 equation (1)

The combined score reflects overall relevance of each URL based on multiple metrics. In a final ranking based on the combined score, for example, a URL 3 (corresponding to shot scene) achieved the highest combined score of 0.823, indicating the best overall relevance across all metrics evaluated. Further, for example, a URL 5 (corresponding to an article “News Dec. 8, 2022” in the article) follows closely with a strong second-highest combined score of 0.807, demonstrating its significant relevance as well.

Further, for the video 904, a step in the data enrichment process includes execution of audio personification 916. The audio personification 916 involves transcribing spoken content (e.g., audio) from the video 904 into text format (e.g., transcript), allowing for a more accessible and analyzable representation of the audio. For example, during the audio personification 916, the transcript captures a specific time in the video 904, for example “00:00:00”, which indicates a starting point of a significant dialogue or scene. As the audio is transcribed, the insights may also be generated. For example, a notable phrase such as “But I'm, in no doubt at all” may be extracted, highlighting a critical time in the conversation that may hold relevance to overall context of the video 904. The audio personification 916 continues as additional timestamps in the transcription may be captured. For example, at “00:00:05”, another significant audio segment is transcribed, highlighting a phrase “And millions of us”. The insights may provide clues about intent of the video 904, audience engagement, or key themes being discussed.

Once the audio personification 916 is completed, the enriched data 914 is generated for the video 904, incorporating all transcriptions 916a along with the associated insights 916b. The enriched data not only includes the transcribed text, which makes the video 904 searchable and easier to review, but also incorporates contextual insights drawn from the dialogue. As a result, a comprehensive view of the video 904 may be obtained, enhancing overall understanding and allowing the moderators to make informed decisions based on both the visual and auditory components of the UGC.

For the second image 906, polyglot translation 918 and visual semantic extraction 920 are performed. The polyglot translation 918 converts original native language “N” written in the second image 906 into a standard language “S”. For example, a translation may be “We will write in history books, and we will make ink, with which we paint”. Further, through the visual semantic extraction 920, an output may be generated. For example, the output may include “The image contains a quote from President ‘X’ in the native language ‘N’ and reads: ‘We will write in history books, and we will make ink, with which we paint’. A quote is superimposed on a powerful photograph of President ‘X,’ standing in front of a flag.” Therefore, the enriched data 914 is generated through the polyglot translation 918 and visual semantic extraction 920, for the second image 906, which may be further stored in the knowledge base 524.

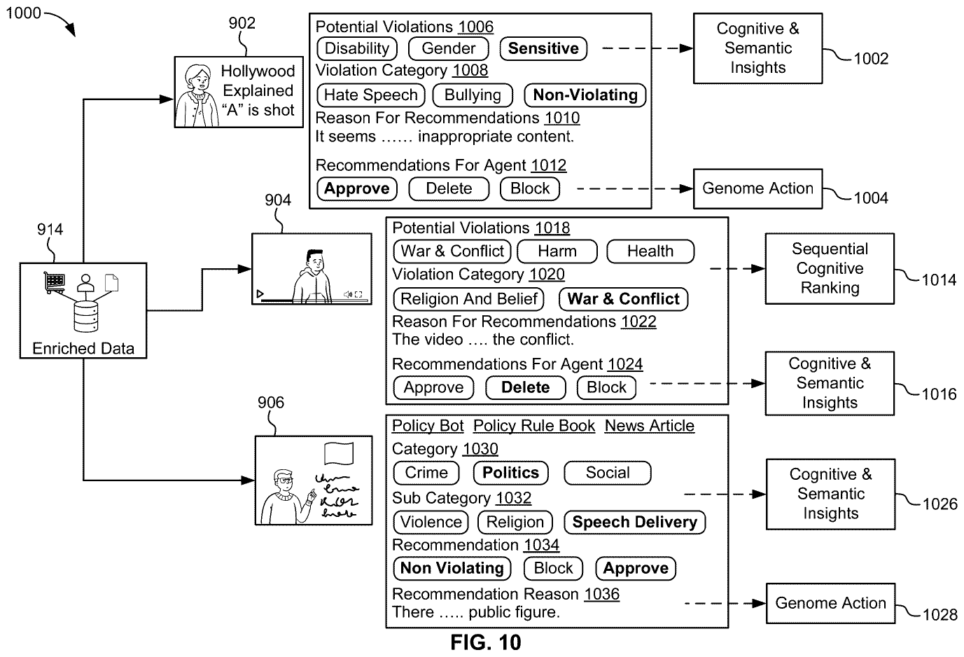

FIG. 10 illustrates an example scenario 1000 of categorizing the UGC into a category based on the enriched data 914, in accordance with implementations of the present disclosure. In some implementations, the scenario 1000 may be implemented within the insights generation system 114. FIG. 10 is explained in conjunction with FIGS. 1-9.

In case of the first image 902, cognitive semantic insights 1002 (e.g., the cognitive and semantic insights 314) and genome action 1004 (e.g., the genome action API 320) may be employed. The cognitive semantic insights 1002 may generate insights that include comprehensive explanations of potential policy breaches. The genome action 1004 facilitates targeted actions or insights based on analysis of the enriched data of the first image 902, and cognitive intelligence on policy (e.g., cognitive intelligence on policy 322) may be employed to provide contextual understanding of relevant policy guidelines. As illustrated in FIG. 10, potential violation 1006 (as sensitive), violation category 1008 (as non-violating), reason for recommendations 1010, recommendations for agent 1012 (as approve) may be generated.

Similarly, in case of the video 904, a sequential cognitive ranking API 1014 (e.g., the sequential cognitive ranking 316) and cognitive and semantic insights 1016 (e.g., the cognitive and semantic insights 314) may be employed. For example, potential violations 1018 at various timestamps in the video 904, a violation category 1020 (as war and conflict), reasons for recommendations 1022, and recommendations for agent 1024 (as delete) may be generated. Further, in case of the second image 906, cognitive and semantic insights 1026 (e.g., the cognitive and semantic insights 314) and genome action 1028 (e.g., the genome action API 320) may be employed. For example, a category 1030 (as policy), a sub-category 1032 (as speech delivery), a recommendation 1034 (as non-violating, and approve), and a recommendation reason 1036 may be generated.

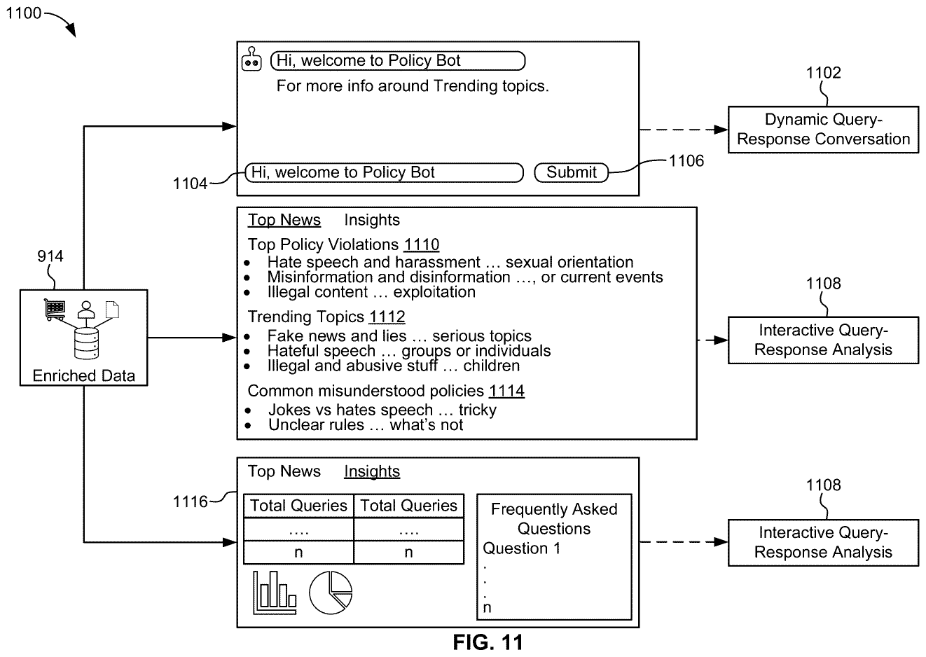

FIG. 11 illustrates an example scenario 1100 of integrating cognitive intelligence to the enriched data 914, in accordance with implementations of the present disclosure. In some implementations, the scenario 1100 may be implemented within the insights generation system 114. FIG. 11 is explained in conjunction with FIGS. 1-10.

As illustrated in FIG. 11, a dynamic query-response conversation 1102 may be generated. For example, the dynamic query-response conversation 1102 includes an auto-generated message “Hi welcome to policy bot . . . you?”, and in a next line “for more info . . . click here?”. Further, the dynamic query-response conversation 1102 may include a type box 1104 where a moderator may enter a query and submit the query through a submit button 1106.

Further, an interactive query-response analysis 1108 may be generated. For example, the interactive query-response analysis 1108 includes top policy violations 1110 including “Hate speech and harassment . . . sexual orientation”, “Misinformation and disinformation . . . , or current events”, and “illegal content . . . exploitation”. The interactive query-response analysis 1108 includes trending topics 1112 including “fake news and lies . . . serious topics”, “hateful speech . . . groups or individuals”, and “illegal and abusive stuff . . . children”, and the like. The interactive query-response analysis 1108 includes common misunderstood policies 1114 including “jokes vs hates speech . . . tricky”, “unclear rules . . . what's not”, and the like. Further, the interactive query-response analysis 1108 may be represented through different graphs and tables 1116 as illustrated in FIG. 11.

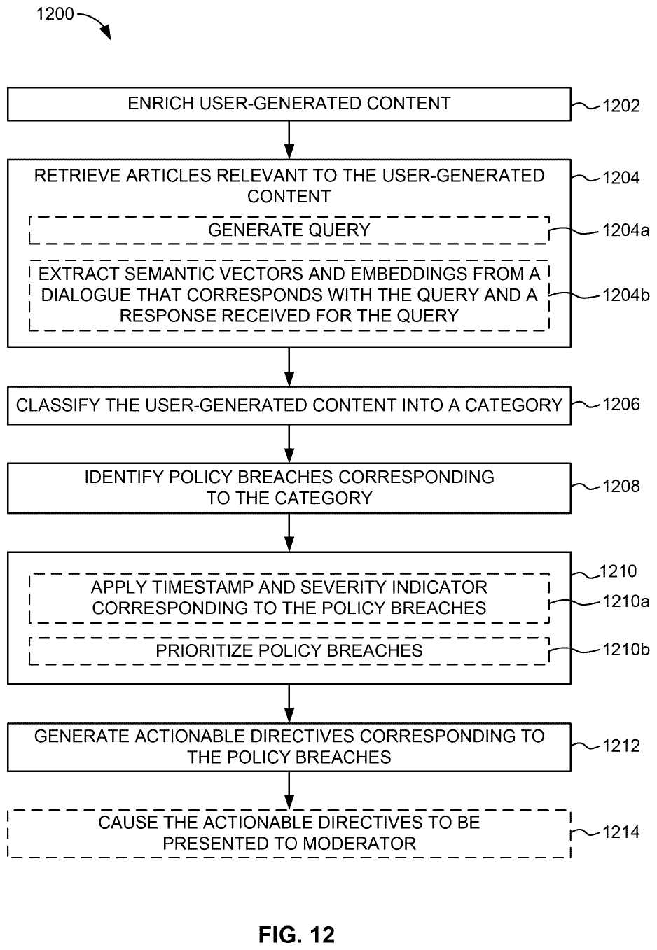

FIG. 12 is a flow diagram that presents an example method 1200 for generating insights for agent-assisted content moderation, in accordance with implementations of the present disclosure. In some implementations, the method 1200 may be executed within the insights generation system 114. FIG. 12 is explained in conjunction with FIGS. 1-11.

The method 1200 includes enriching 1202 user-generated content (UGC) for enhancing accessibility and comprehension, the user-generated content stored in a database. The UGC may be enriched 1202 based upon one or more of image description, audio transcription, audio and/or video extraction, speech recognition, and/or machine translation. To enrich 1202 the UGC, textual analysis methods may be used.

The method 1200 includes retrieving 1204 articles relevant to the UGC. The articles may include, but are not limited to, an emerging trend, prevalent policy violations, policy information, and a trending topic. The articles relevant to the UGC may be identified based upon keywords and vector embeddings and based upon a respective similarity score of each article of the plurality of articles. The respective similarity score of each article may be computed based upon a cosine similarity, a silhouette score, and an accuracy score. The articles may be retrieved 1204 by generating 1204a a query using NLP techniques. Further, upon generating 1204a the query, to retrieve 1204 the articles, semantic vectors and embeddings are extracted 1204b from a dialogue. Here, the dialogue may correspond with the query and a response received for the query. The articles may be retrieved 1204 through web-scrapping. The articles may fortify contextual relevance and/or comprehension.

The method 1200 includes classifying 1206 the enriched UGC into a content category of various content categories. The enriched UGC may be classified using one or more transformers and contextual embeddings. For example, the categories may include, but are not limited to, hate speech, misinformation, harassment, adult content, spam, and copyright violations, and the like. The method 1200 further includes identifying 1208, based on the enriched UGC and the retrieved articles, policy breaches corresponding to the classified content category. Machine Learning (ML) techniques may be used to evaluate the UGC against a predefined policy criteria specific to the content category.

The method 1200 includes generating 1210 cognitive ranking of the one or more of the policy breaches. The cognitive ranking may be generated 1210 by applying 1210a a timestamp and a severity indicator corresponding to each of the policy breaches. Further, the policy breaches may be prioritized 1210b based upon the severity indicator corresponding to each of the policy breaches. By way of an example, the cognitive ranking may be first, second, third, and the like. By way of another example the cognitive ranking may including highest priority, medium priority, medium-low priority, lowest priority, and the like. Generation of the cognitive ranking is already explained in detail in conjunction with the ranking generation module 216 in FIG. 2.

The method 1200 includes generating 1212 actionable directives corresponding to the one or more of the policy breaches for the UGC, based upon the cognitive ranking of the one or more of the policy breaches. The actionable directives may include one or more of a content categorization recommendation, a list of policy violations, and a list of recommended actions, based on policy guidelines. In an implementation, information providing clarification corresponding to the one or more policy breaches may be generated. The information may include explanations of the specific terms or phrases that triggered the violation, enhancing transparency and understanding for both the moderators and the users 110 and 112. Further, an emerging trend and/or a common policy violation may be identified for the UGC. The method 1200 includes causing 1214 the actionable directives to be presented to a moderator.

Implementations of the present disclosure provide technical solutions to multiple technical problems that arise in generating insights for agent-assisted content moderation. Implementations of the present disclosure provide enhanced efficiency in content moderation by integrating Artificial Intelligence (AI) technologies that accelerate review process of the content. Therefore, moderators may handle large volumes of the content more effectively and swiftly, ultimately improving productivity. Additionally, the implementation of the present disclosure enhance consistency in policy application, ensuring that moderation decisions align uniformly with established guidelines across a platform.

Furthermore, the implementations support comprehensive contextual understanding by analyzing content patterns and integrating insights generated by the insights generation system 114. As a result, understanding of moderators with respect to content dynamics may be enhanced and the moderators may be equipped to make well-informed decisions. By automating routine tasks and providing rich insights, the insights generation system 114 allows the moderators to focus on more complex cases that require human judgment and expertise. The implementations also offer accurate content analysis through features like cognitive attention and cognitive and semantic insights, which provide detailed analyses of the content, thereby enhancing understanding of context and potential policy breaches of the moderators. Moreover, a streamlined information retrieval technique used by the information retrieval URL significantly reduces time and effort required for the moderators to gather pertinent information by quickly identifying relevant articles and sources.

Implementations further provide improved decision-making, which is another advantage, as actionable insights generated by the insights generation system 114 empower the moderators to make informed judgments, leading to improved outcomes in the content moderation. Further, the standardized classification provided by the sequential cognitive ranking technique minimizes classification errors and enhances reliability of content flagging. The sequential cognitive ranking technique allows the moderators to efficiently triage content based on established priority levels. Furthermore, the implementations support comprehensive contextual understanding by analyzing content patterns and integrating insights from interactions with the insights generation system 114. As a result, a deeper comprehension of content dynamics is facilitated, empowering the moderators to make informed decisions.

By automating routine tasks and providing rich insights, the insights generation system 114 allows the moderators to focus on more complex cases that require human judgment and expertise. Finally, the implementations include integration with client environment seamlessly, as direct data analysis is conducted to generate insights without disrupting existing workflows. The cognitive attention feature enhances extraction and conversion of information from various media formats, ensuring precision and accessibility across diverse content types. Meanwhile, the cognitive intelligence on policy integration offers streamlined access to a policy rulebook and relevant knowledge base articles, further enhancing decision-making capabilities and ensuring adherence to platform standards.

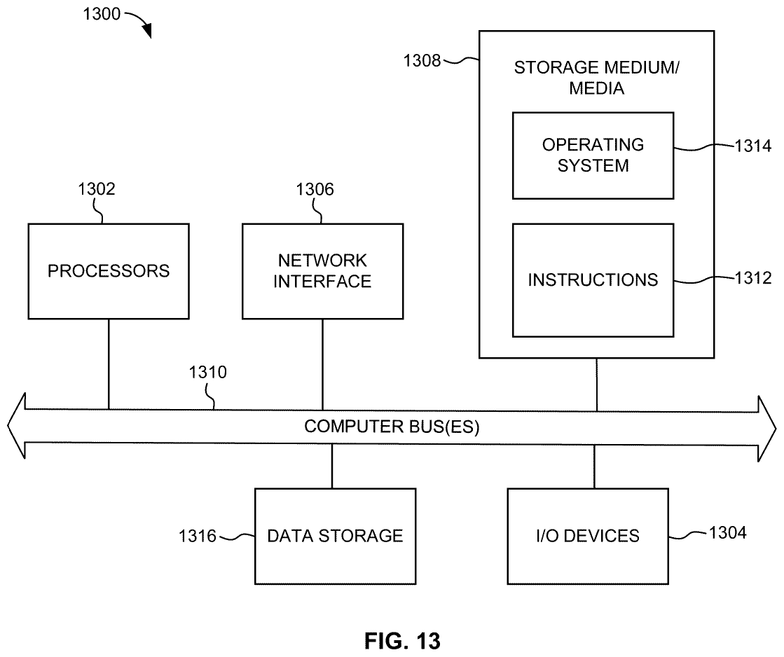

FIG. 13 illustrates a computer system 1300 that may be used to implement the insights generation system 114. More particularly, computing machines such as desktops, laptops, smartphones, tablets, and/or wearable electronic devices which may be used for generating insights for agent-assisted content moderation and may have the structure of the computer system 1300. The computer system 1300 may include additional components not shown and that some of the process components described may be removed and/or modified. In another example, a computer system 1300 may be deployed on external-cloud platforms such as cloud, internal corporate cloud computing clusters, organizational computing resources, and/or the like.

The computer system 1300 includes processor(s) 1302, such as a central processing unit, a controller, an application specific integrated circuit (ASIC), or another type of processing circuit, input/output devices (I/O) 1304, such as a display, a mouse, a keyboard, etc., a network interface 1306, such as a Local Area Network (LAN) interface, a wireless 802.11x interface, a 3G, 4G, 5G, or 6G mobile WAN or a WiMax WAN, and a computer-readable medium 1308. Each of these components may be operatively coupled each other via one or more computer bus(es) 1310. The computer-readable medium 1308 may be any suitable medium that participates in providing instructions to the processor(s) 1302 for execution. For example, the computer-readable medium 1308 may be non-transitory or non-volatile medium, such as a magnetic disk or solid-state non-volatile memory or volatile medium such as RAM. The instructions or modules stored on the computer-readable medium 1308 may include machine-readable or machine-executable instructions or code 1312 executed by the processor(s) 1302 that cause the processor(s) 1302 to perform the methods and functions of the insights generation system 114.

The insights generation system 114 may be implemented as software stored on a non-transitory computer-readable medium and executed by the processors 1302. For example, the computer-readable medium 1308 may store an operating system 1314, such as MAC OS, MS WINDOWS, UNIX, or LINUX, and code 1312 for the insights generation system 114. The operating system 1314 may be multi-user, multiprocessing, multitasking, multithreading, real-time, and the like. For example, during runtime, the operating system 1314 and the code for the insights generation system 114 are executed by the processor(s) 1302.

The computer system 1300 may include a data storage 1316, which may include non-volatile data storage. The data storage 1316 stores any data used or generated by the insights generation system 114.

The network interface 1306 connects the computer system 1300 to external systems for example, via a LAN. Also, the network interface 1306 may connect the computer system 1300 to the Internet. For example, the computer system 1300 may connect to web browsers and other external applications and systems via the network interface 1306.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (e.g., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for generating insights for agent-assisted content moderation, the computer-implemented method comprising:
enriching user-generated content (UGC) for enhancing accessibility and comprehension, the UGC stored in a database;
retrieving a plurality of articles relevant to the user-generated content;
classifying the UGC into at least one content category of a plurality of content categories;
identifying, based on the enriched UGC and the retrieved plurality of articles, one or more of a plurality of policy breaches corresponding to the at least one content category;
generating cognitive ranking of the one or more of the plurality of policy breaches; and
generating, based upon the cognitive ranking of the one or more of the plurality of policy breaches, one or more actionable directives corresponding to the one or more of the plurality of policy breaches for the user-generated content.

2. The computer-implemented method of claim 1, further comprising causing the one or more actionable directives to be presented to a moderator, wherein the one or more actionable directives comprises one or more of: a content categorization recommendation, a list of policy violations, and a list of recommended actions, based on policy guidelines.

3. The computer-implemented method of claim 2, further comprising generating information providing clarification corresponding to the one or more of the plurality of policy breaches.

4. The computer-implemented method of claim 2, further comprising identifying an emerging trend and/or a common policy violation for the user-generated content.

5. The computer-implemented method of claim 1, wherein:
the plurality of articles comprises one or more of: an emerging trend, prevalent policy violations, policy information, and a trending topic;
the plurality of articles relevant to the UGC is identified based upon keywords and vector embeddings and based upon a respective similarity score of each article of the plurality of articles; and
the respective similarity score of each article is computed based upon a cosine similarity, a silhouette score, and an accuracy score.

6. The computer-implemented method of claim 1, wherein retrieving the plurality of articles relevant to the UGC comprises:
using natural language processing (NLP) techniques to generate a query; and
extracting semantic vectors and embeddings from a dialogue, the dialogue corresponds with the query and a response received for the query.

7. The computer-implemented method of claim 1, wherein generating the cognitive ranking of the one or more of the plurality of policy breaches comprises applying a timestamp and a severity indicator corresponding to each of the one or more of the plurality of policy breaches, and prioritizing the one or more of the plurality of policy breaches based upon the severity indicator corresponding to each of the one or more of the plurality of policy breaches.

8. The computer-implemented method of claim 1, wherein classifying the UGC into the at least one content category comprises using one or more transformers and contextual embeddings to classify the UGC into the at least one content category.

9. The computer-implemented method of claim 1, wherein retrieving the plurality of articles relevant to the UGC comprises retrieving the plurality of articles through web-scrapping, and wherein the plurality of articles fortifies contextual relevance and/or comprehension.

10. The computer-implemented method of claim 1, wherein enriching the UGC comprises enriching the UGC based upon one or more of: image description, audio transcription, audio and/or video extraction, speech recognition, and/or machine translation.

11. The computer-implemented method of claim 1, wherein the UGC is enriched using one or more textual analysis algorithms.

12. A system for generating insights for agent-assisted content moderation, the system comprising:
at least one memory to store executable instructions; and
at least one processor communicatively coupled with the at least one memory and to execute the executable instructions to perform operations comprising:
enriching user-generated content (UGC) for enhancing accessibility and comprehension, the UGC stored in a database;
retrieving a plurality of articles relevant to the user-generated content;
classifying the UGC into at least one content category of a plurality of content categories;
identifying, based on the enriched UGC and the retrieved plurality of articles, one or more of a plurality of policy breaches corresponding to the at least one content category;
generating cognitive ranking of the one or more of the plurality of policy breaches; and
generating, based upon the cognitive ranking of the one or more of the plurality of policy breaches, one or more actionable directives corresponding to the one or more of the plurality of policy breaches for the user-generated content.

13. The system of claim 12, wherein the operations further comprising:
causing the one or more actionable directives to be presented to a moderator, wherein the one or more actionable directives comprises one or more of: a content categorization recommendation, a list of policy violations, and a list of recommended actions, based on policy guidelines;
generating information providing clarification corresponding to the one or more of the plurality of policy breaches; and
identifying an emerging trend and/or a common policy violation for the user-generated content.

14. The system of claim 12, wherein:
the plurality of articles comprises one or more of: an emerging trend, prevalent policy violations, policy information, and a trending topic;
the plurality of articles relevant to the UGC is identified based upon keywords and vector embeddings and based upon a respective similarity score of each article of the plurality of articles; and
the respective similarity score of each article is computed based upon a cosine similarity, a silhouette score, and an accuracy score.

15. The system of claim 12, wherein retrieving the plurality of articles relevant to the UGC comprises:
using natural language processing techniques to generate a query; and
extracting semantic vectors and embeddings from a dialogue, the dialogue corresponds with the query and a response received for the query.

16. The system of claim 12, wherein generating the cognitive ranking of the one or more of the plurality of policy breaches comprises applying a timestamp and a severity indicator corresponding to each of the one or more of the plurality of policy breaches, and prioritizing the one or more of the plurality of policy breaches based upon the severity indicator corresponding to each of the one or more of the plurality of policy breaches.

17. The system of claim 12, wherein classifying the UGC into the at least one content category comprises using one or more transformers and contextual embeddings to classify the UGC into the at least one content category.

18. The system of claim 12, wherein retrieving the plurality of articles relevant to the UGC comprises retrieving the plurality of articles through web-scrapping, and wherein the plurality of articles fortifies contextual relevance and/or comprehension.

19. The system of claim 12, wherein enriching the UGC comprises enriching the UGC based upon one or more of: image description, audio transcription, audio and/or video extraction, speech recognition, and/or machine translation; or enriching the UGC using one or more textual analysis algorithms.

20. A non-transitory computer readable media storing instruction thereon, which, when executed by at least one processor of a computing device, cause the computing device to generate insights for agent-assisted content moderation by performing operations comprising:
enriching user-generated content (UGC) for enhancing accessibility and comprehension, the UGC stored in a database;
retrieving a plurality of articles relevant to the user-generated content;
classifying the UGC into at least one content category of a plurality of content categories;
identifying, based on the enriched UGC and the retrieved plurality of articles, one or more of a plurality of policy breaches corresponding to the at least one content category;
generating cognitive ranking of the one or more of the plurality of policy breaches; and
generating, based upon the cognitive ranking of the one or more of the plurality of policy breaches, one or more actionable directives corresponding to the one or more of the plurality of policy breaches for the user-generated content.
